(19) United States
(12) Patent Application Publication
(10) Pub. No.: US 2026/0298375 A1
(43) Pub. Date: Oct. 1, 2026

(54) TUBE FOR AN AIR BRAKE LINE

(71) Applicant: TI Automotive (Fuldabrück) GmbH, Fuldabrück (DE)

(72) Inventor: Siegfried ARNOLD, Kassel (DE)

(21) Appl. No.: 19/631,274

(22) Filed: Mar. 27, 2026

(30) Foreign Application Priority Data
Mar. 28, 2025 (DE) 102025112248.2

(51) Int. Cl. F16L 11/04; B32B 1/08; B32B 27/08; B32B 27/34; B60T 17/04

(52) U.S. Cl. CPC F16L 11/04; B32B 1/08; B32B 27/08; B32B 27/34; B60T 17/04; B32B 2250/03; B32B 2250/24; B32B 2307/7376; B32B 2597/00

(57) ABSTRACT

A tube for conveying compressed air includes an inner layer, an inner adhesion promoter layer, and a carrier layer. The inner adhesion promoter layer 3 is arranged between the carrier layer 4 and the inner layer, and the carrier layer comprises a PA6 and the inner layer comprises a polyamide. The inner adhesion promoter layer comprises a first polyamide and a second polyamide, wherein the first polyamide of the inner adhesion promoter layer is a PA12.

### RELATED APPLICATIONS

The present disclosure claims priority to and the benefit of German Application 10 2025 112 248.2, filed on Mar. 28, 2025, the entire contents of each of which are incorporated herein by reference.

### FIELD

The present disclosure relates to a tube, in particular for conveying compressed air, comprising an inner layer, an inner adhesion promoter layer, and a carrier layer, wherein the inner adhesion promoter layer is arranged between the carrier layer and the inner layer, wherein the carrier layer comprises a PA6, wherein the inner layer comprises a polyamide, wherein the inner adhesion promoter layer comprises a first polyamide, wherein the inner adhesion promoter layer comprises a second polyamide. The present disclosure also relates to a use of this tube.

### BACKGROUND

Such an air brake line tube is known from US 2009/0065085 A1 and comprises a total of five layers. The inner layer (0.15 mm) comprises an impact-modified PA12 with a plasticizer. An adjacent inner adhesion promoter layer (0.1 mm) comprises approximately 62 wt % PA6.12, 16 wt % PA6, and in addition 8 wt % plasticizer (BBSA) and 11 wt % impact modifier. The adhesion promoter layer is enclosed by a relatively thick carrier layer (0.5 mm) comprising 87 wt % PA6 and 12 wt % plasticizer (BBSA). This is followed by an outer adhesion promoter layer (0.1 mm) with a composition identical to that of the inner adhesion promoter layer. Finally, the outer layer (0.15 mm) comprises a composition identical to that of the inner layer.

A disadvantage of the known tube is that it is exposed to high and fluctuating air pressures (>25 bar) and, in particular, we have discovered there is a risk of delamination of layers.

### SUMMARY

The present disclosure provides a particularly pressure-stable tube whose manufacturing costs are low and which, at the same time, does not tend to delaminate even at the pressures mentioned.

A tube, in particular for conveying compressed air, comprises an inner layer, an inner adhesion promoter layer, and a carrier layer, wherein the inner adhesion promoter layer is arranged between the carrier layer and the inner layer, wherein the carrier layer comprises a PA6, wherein the inner layer comprises a polyamide, wherein the inner adhesion promoter layer comprises a first polyamide, wherein the inner adhesion promoter layer comprises a second polyamide, characterized in that the first polyamide of the inner adhesion promoter layer is a PA12.

The present disclosure includes the discovery that PA6 is a very pressure-resistant and at the same time inexpensive plastic, so that PA6 is very well suited as a carrier layer for tubes of compressed air lines. However, PA6 is less chemically stable than PA12, for example, so that PA12 is more suitable than PA6 as an inner and/or outer layer. Since PA6 does not adhere sufficiently to PA12, US 2009/0065085 A1 uses an inner and an outer adhesion promoter layer.

It has been found that air brake lines, which are subject to high pressures, place exceptional demands on the tubes of the air brake lines due to constant pressure fluctuations over the lifetime of a vehicle. The present disclosure recognizes that the tubes of the prior art still have room for improvement in terms of long-term pressure resistance under automotive conditions (very low but also very high temperatures possible, as well as considerable chemical stress from salts, oils, fuels, etc.). In particular, after a few years, material aging, constant pressure fluctuations in the tube, and vibrations in the vehicle can cause delamination between the inner or outer layer on the one hand and the respective adhesion promoter layer on the other.

The present disclosure is based in particular on the realization that this found delamination can be counteracted by adding PA12 to the inner adhesion promoter layer. It has been found that PA12 in the inner adhesion promoter layer is responsible for excellent adhesion to the inner layer when the inner layer comprises PA12, PA11, and/or PA6.12. This is surprising insofar as, in the prior art, PA6.12 is provided as the main component in the adhesion promoter layer and PA6.12 adheres quite well to PA12, PA11, and PA6.12 inner layers due to the 12-monomer. However, the provision of PA12 in the inner adhesion promoter layer further improves adhesion.

Finally, it was found that the inner adhesion promoter layer could also be made sufficiently adhesive by adding a suitable additive to increase the adhesive effect. However, such additives must be specially tailored to the adhesion promoter layer and the surrounding layers, which is a complex and correspondingly costly process. Due to the low layer thickness of the inner adhesion promoter layer, this procedure or this layer-specific composition is not economical, which is why this variant is ruled out. The mixture of two polyamides, as proposed by the present disclosure, is significantly more economical. As a result, the task mentioned at the beginning was solved.

The inner layer is preferably the innermost layer of the tube and is in contact with the medium transported by the tube. Conveniently, the inner layer defines a lumen of the tube. The inner layer and/or the inner adhesion promoter layer and/or the carrier layer and/or the outer adhesion promoter layer and/or the outer layer is/are preferably (in each case) formed in one piece and, in particular, homogeneously.

The term “homogeneous” preferably means that a layer originates from only one melt or was extruded from only one extruder nozzle. The term “homogeneous” preferably means that the composition of the homogeneous body is the same or essentially the same at all points. There is preferably an interface between two (homogeneous) layers. The tube is preferably formed in one piece and, in particular, composed of a plurality of homogeneous layers. The term “one piece” preferably means that the one-piece construction can only be converted into a multi-piece construction in an irreversible or destructive manner.

According to a particularly preferred embodiment, the second polyamide of the inner adhesion promoter layer is a PA6.12, wherein the weight proportion of the second polyamide or PA6.12 in the inner adhesion promoter layer is less than 70, 60, 50, 40, 30, or 20%, respectively. This results in a sufficiently high proportion of PA12 in the inner adhesion promoter layer, thereby achieving a particularly good bond to the inner layer. Advantageously, the weight proportion of PA6.12 in the inner adhesion promoter layer is at least 10, 20, or 30 wt %.

Preferably, the weight proportion of the first polyamide or PA12 in the inner adhesion promoter layer is at least 30, 40, 50, 60, 70, or 80%. Advantageously, the weight percentage of the first polyamide or PA12 in the inner adhesion promoter layer is at most 90, 80, 70, 60, 50, 40, or 30%.

It is highly preferred that the inner layer comprises an aliphatic polyamide, preferably an aliphatic polyamide with more than 6 or 9 carbon atoms per repeating unit. The inner layer advantageously comprises PA12 and/or PA11 and/or PA6.12 and/or PA10.10 and/or PA10.12 and/or PA6.10. This chemically shields the carrier layer from the lumen or the medium of the tube. In particular, oils or air humidity in the lumen can have a negative effect on the carrier layer or the PA6 in the carrier layer, from which the inner layer protects the carrier layer. The inner layer may comprise a plasticizer and/or an impact modifier. It is highly preferred that a polyamide content or a content of the aliphatic polyamide or aliphatic polyamides or a content comprising PA12 and/or PA11 and/or PA6.12 and/or PA10.10 and/or PA10.12 and/or PA6.10 amounts to at least 20 or 30 or 40 or 50 or 60 or 70 or 80 wt % of the inner layer. Advantageously, a polyamide proportion or a proportion of the aliphatic polyamide or aliphatic polyamides or a proportion comprising PA12 and/or PA11 and/or PA6.12 and/or PA10.10 and/or PA10.12 and/or PA6. 10 is at most 99, 97, or 95 wt % of the inner layer.

According to a highly preferred embodiment, the carrier layer is at least 0.6, 0.7, or 0.8 mm thick. This achieves a high compressive strength of the tube. This also means that the carrier layer has a mechanically dominant function within the tube. Preferably, the layer thickness of the carrier layer is at most 3.0, 2.5, or 2.0 mm. It is highly preferred that the ratio of the thickness of the carrier layer to the wall thickness of the tube is at least 0.4, 0.5, 0.6, or 0.7. It is advantageous that the ratio of the thickness of the carrier layer to the wall thickness of the tube is at most 0.95, 0.9, 0.85, or 0.8, respectively.

It is advantageous for the carrier layer to have a polyamide content or a PA6 content of at least 20, 30, 40, 50, 60, 70, 80, or 90 wt %. Preferably, the carrier layer has a polyamide content or a PA6 content of at most 99, 97, or 95 wt %.

It is advantageous for the inner adhesion promoter layer to contact the inner layer and/or the carrier layer. This results in good adhesion. In addition, this ensures that the tube has as few layers as possible. It is highly preferred that the layer thickness of the inner adhesion promoter layer is at most 0.30, 0.25, 0.20, 0.15, 0.10, or 0.08 mm. It is expedient for the inner adhesion promoter layer to surround the inner layer. Preferably, the carrier layer surrounds the inner adhesion promoter layer.

Preferably, the tube comprises an outer layer, wherein the outer layer advantageously comprises an aliphatic polyamide, preferably an aliphatic polyamide with more than 6 or 9 carbon atoms per repeating unit. The outer layer advantageously comprises PA12 and/or PA11 and/or PA6.12 and/or PA10.10 and/or PA10.12 and/or PA6.10. This protects the carrier layer from environmental influences, in particular from water, salts, oils, fuels, and the like. It is possible that the outer layer comprises a plasticizer and/or an impact modifier. Advantageously, a polyamide content or a content of aliphatic polyamide or aliphatic polyamides or a content comprising PA12 and/or PA11 and/or PA6.12 and/or PA10.10 and/or PA 10.12 and/or PA6. 10 is at least 20 or 30 or 40 or 50 or 60 or 70 or 80 wt % of the outer layer. Advantageously, a polyamide proportion or a proportion of the aliphatic polyamide or aliphatic polyamides or a proportion comprising PA12 and/or PA11 and/or PA6.12 and/or PA10.10 and/or PA10.12 and/or PA6. 10 is preferably 99, 97, or 95 wt % of the outer layer, respectively.

The tube preferably comprises an outer adhesion promoter layer. This ensures good adhesion between the carrier layer and the outer layer. The outer adhesion promoter layer is conveniently arranged between the outer layer and the carrier layer. Advantageously, the outer adhesion promoter layer contacts the carrier layer and/or to the outer layer. Conveniently, the outer adhesion promoter layer surrounds the carrier layer. Preferably, the outer layer surrounds the outer adhesion promoter layer. It is highly preferred that the layer thickness of the outer adhesion promoter layer is at most 0.30 or 0.25 or 0.20 or 0.15 or 0.10 or 0.08 mm. Preferably, the outer adhesion promoter layer comprises a first polyamide. Advantageously, the outer adhesion promoter layer has a second polyamide.

It is highly preferred that the first polyamide of the outer adhesion promoter layer is a PA12. Preferably, the weight proportion of the first polyamide or PA12 in the outer adhesion promoter layer is at least 30, 40, 50, 60, 70, or 80%, respectively. Preferably, the weight proportion of the first polyamide or PA12 in the outer adhesion promoter layer is at most 90%, 80%, 70%, 60%, 50%, 40%, or 30%.

According to a particularly preferred embodiment, the second polyamide of the outer adhesion promoter layer is a PA6.12, wherein the weight proportion of the second polyamide or PA6.12 in the outer adhesion promoter layer is less than 60, 50, or 40%. Advantageously, the weight proportion of the second polyamide or PA6.12 in the outer adhesion promoter layer is at least 10, 20, or 30 wt %. This results in a relatively high proportion of PA12 in the outer adhesion promoter layer, thereby achieving a particularly good bond to the outer layer.

Preferably, the wall thickness of the tube is at least 0.8, 0.9, or 1.0 mm. This enables high compressive strength. Preferably, the wall thickness of the tube is at most 3.5, 3.0, or 2.5 mm.

Advantageously, the inner layer and/or the outer layer has a layer thickness of at most 0.40 or 0.30 or 0.20 or 0.15 mm. This means that the carrier layer is the mechanically dominant layer within the tube, so that the inner layer and/or the outer layer is/are essentially limited to the chemical function. The inner layer and/or the outer layer advantageously has/have a layer thickness of at least 0.05, 0.07, or 0.09 mm.

The task mentioned at the beginning is solved by using a tube according to the present disclosure as a tube for conducting compressed air, preferably within a vehicle, in particular as a tube of an air brake line.

### BRIEF DESCRIPTION OF THE DRAWINGS

The present disclosure is explained below with reference to an embodiment using a figure. It shows

FIG. 1 a perspective view of a tube according to the present disclosure for an air brake line.

### DETAILED DESCRIPTION

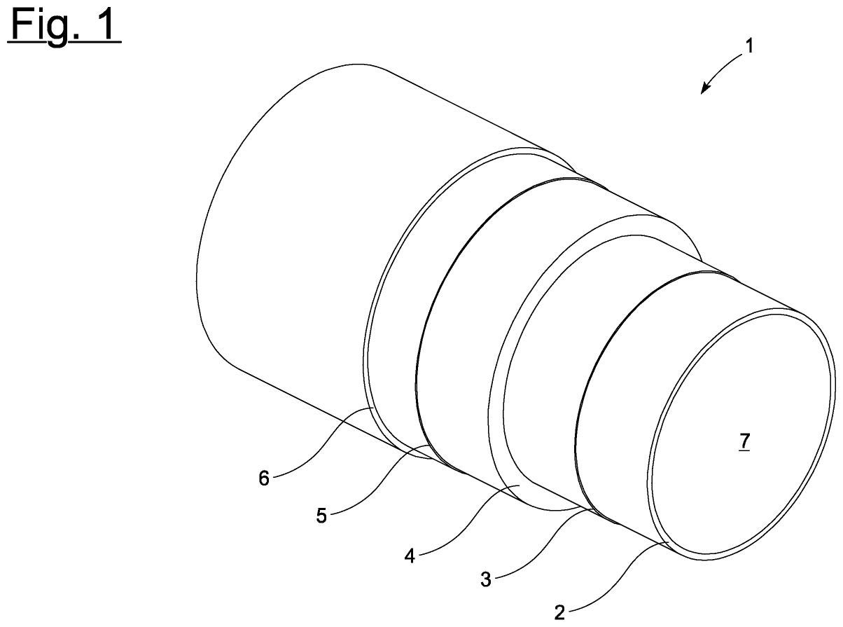

FIG. 1 shows a perspective view of a tube 1 for an air brake line of a vehicle. The individual layers 2-6 are drawn in steps, but this is only for the sake of clarity. The tube 1 of the embodiment must withstand fluctuating pressures above 25 bar and is designed for automotive conditions, so that it is designed for a correspondingly long service life and for corresponding weather conditions.

The tube 1 of the embodiment preferably comprises five layers. The tube 1 has an inner layer 2 which delimits a lumen 7 of the tube 1, so that the inner layer 1 comes into contact with the medium inside the tube 1. The medium is compressed air with humidity levels that fluctuate depending on the weather, whereby small amounts of contaminants may also be mixed in with the compressed air. These may be substances such as oils and the like, which may be used within a pneumatic circuit.

The tube 1 comprises an inner adhesion promoter layer 3 and a carrier layer 4. The inner adhesion promoter layer 3 is arranged between the inner layer 2 and the carrier layer 4 so that the carrier layer encloses the inner adhesion promoter layer 3. The tube 1 preferably comprises an outer layer 6 and, preferably, an outer adhesion promoter layer 5. The outer adhesion promoter layer 5 is preferably arranged between the carrier layer 4 and the outer layer 6.

The carrier layer 4 conveniently comprises a polyamide and, preferably, a PA6. The weight proportion of the polyamide or PA6 in the carrier layer 4 is preferably at least 50, 60, or 70 wt %. The carrier layer 4 may contain at least one additive, for example an additive for increasing impact strength (impact modifier).

It is highly preferred that the carrier layer 4 has a thickness of at least 0.8 or 1.0 mm. In this embodiment, the ratio of the layer thickness of the carrier layer 4 relative to the wall thickness of the tube 1 is at least 0.6 or 0.7. In this embodiment, the carrier layer 4 is the mechanically dominant layer of the tube 1.

The inner layer 2 of this embodiment may comprise PA12 and/or PA11 and/or PA6.12. It is particularly preferred that the inner layer 2 comprises only one polyamide, namely PA12. It is highly preferred that the polyamide content of the inner layer 2 amounts to at least 60 or 70 wt %. Advantageously, the inner layer 2 comprises a plasticizer and/or an impact modifier. Advantageously, the layer thickness of the inner layer 2 amounts to at most 0.2 or 0.15 mm.

The inner adhesion promoter layer 3 comprises PA12 and preferably PA6.12. It is highly preferred that the proportion of PA12 in the inner adhesion promoter layer 3 amounts to at least 50 or 60 wt %. The proportion of PA6.12 in the inner adhesion promoter layer 3 is preferably a maximum of 50 or 40 wt %. It is highly preferred that the inner adhesion promoter layer 3 has a layer thickness of a maximum of 0.15 or 0.12 or 0.10 or 0.08 mm.

The outer layer 6 of this embodiment may comprise PA12 and/or PA11 and/or PA6.12. It is particularly preferred that the outer layer 6 comprises only one polyamide, namely PA12. It is highly preferred that the polyamide content of the outer layer 6 is at least 60 or 70 wt %. Advantageously, the outer layer 6 comprises a plasticizer and/or an impact modifier. A layer thickness of the outer layer 6 advantageously amounts to at most 0.2 or 0.15 mm.

The outer adhesion promoter layer 5 comprises PA12 and preferably PA6.12. It is highly preferred that the proportion of PA12 in the outer adhesion promoter layer 5 amounts to at least 50 or 60 wt %. The proportion of PA6.12 in the outer adhesion promoter layer 5 is preferably a maximum of 50 or 40 wt %. It is highly preferred that the outer adhesion promoter layer 5 has a layer thickness of a maximum of 0.15, 0.12, 0.10 or 0.08 mm.

### LIST OF REFERENCE SYMBOLS

1 Tube
2 Inner layer
3 Inner adhesion promoter layer
4 Carrier layer
5 Outer adhesion promoter layer
6 Outer layer
7 Lumen

1. A tube for conveying compressed air, comprising an inner layer, an inner adhesion promoter layer, and a carrier layer, wherein the inner adhesion promoter layer is arranged between the carrier layer and the inner layer, wherein the carrier layer comprises a PA6, wherein the inner layer comprises a polyamide, wherein the inner adhesion promoter layer comprises a first polyamide, wherein the inner adhesion promoter layer comprises a second polyamide, and wherein the first polyamide of the inner adhesion promoter layer is a PA12.

2. The tube according to claim 1, wherein the second polyamide of the inner adhesion promoter layer is a PA6.12, wherein the weight proportion of the PA6.12 in the inner adhesion promoter layer is less than 60%, 50% or 40%.

3. The tube according to claim 1, wherein the inner layer comprises an aliphatic polyamide with more than 6 or 9 carbon atoms per repeating unit.

4. The tube according to claim 1, wherein the carrier layer is at least 0.6 mm thick, respectively.

5. The tube according to claim 1, wherein the inner adhesion promoter layer contacts the inner layer and/or the carrier layer.

6. The tube according to claim 1, wherein the tube comprises an outer layer, wherein the outer layer comprises an aliphatic polyamide with more than 6 or 9 carbon atoms per repeating unit.

7. The tube according to claim 1, wherein the tube has an outer adhesion promoter layer.

8. The tube according to claim 1, wherein the wall thickness of the tube is at least 0.8 mm.

9. The tube according to claim 1, wherein the inner layer and/or the outer layer has a layer thickness of at most 0.4 mm.

10. Use of the tube according to claim 1 as a tube for conveying compressed air within a vehicle, the tube forming part of an air brake line.

11. The tube according to claim 3, wherein the inner layer comprises a PA12, and/or PA11 and/or PA6.12 and/or PA10.10 and/or PA10.12 and/or PA6.10.

12. The tube according to claim 1, wherein the carrier layer is at least 0.8 mm thick.

13. The tube according to claim 6, wherein the outer layer comprises a PA12, and/or PA11 and/or PA6.12 and/or PA10.10 and/or PA10.12 and/or PA6.10.

14. The tube according to claim 1, wherein the wall thickness of the tube is at least 1.0 mm.

15. The tube according to claim 1, wherein the inner layer and/or the outer layer has a layer thickness of at most 0.2 mm.
